(19) United States
(12) Patent Application Publication
(10) Pub. No.: US 2014/0338758 A1
(43) Pub. Date: Nov. 20, 2014

(54) DRAIN LINE ACCESS DEVICE

(71) Applicant: MSD Research, Inc., Boca Raton, FL (US)

(72) Inventors: Stuart Oakner, Boca Raton, FL (US); Donna Oakner, Boca Raton, FL (US)

(21) Appl. No.: 14/451,589

(22) Filed: Aug. 5, 2014

Related U.S. Application Data
(63) Continuation-in-part of application No. 13/953,948, filed on Jul. 30, 2013.
(60) Provisional application No. 61/716,238, filed on Oct. 19, 2012.

(51) Int. Cl. B08B 9/027

(52) U.S. Cl. CPC B08B 9/027
USPC 137/240; 137/238

(57) ABSTRACT

A drain line valve device is provided for flushing HVACR drain lines. The device includes a main valve body having inlet and outlet connection ports on opposite ends for inline installation to a drain line (between the condensation producing source and drain discharge). The device includes a removable top cover and an adapter that is sized and configured for insertion into the interior cavity of the main body and fitted receipt within the inside of one of the input or outlet ports. The adapter allows for connection of a pressurized gas or liquid flow source for clearing clogs in the drain line, or a vacuum source, as well as pouring of a liquid clog-cleaning product into the drain line. One embodiment of the device includes a main valve body having one connection port for connection with an auxiliary outlet of a drain pan. An overflow safety switch is supported by the top cover in the interior cavity of the main valve body for detecting a clog in the drain line.

This patent application is Continuation-In-Part of patent application Ser. No. 13/953,948 filed on Jul. 30, 2013, which is based on provisional patent application Ser. No. 61/716,238 filed on Oct. 19, 2012.

### BACKGROUND OF THE INVENTION

1. Field of the Invention

This invention relates to a device for cleaning drain lines and other fluid transfer conduits and, more particularly, to an inline device that is particularly suited for cleaning and removing clogs in air conditioning and refrigeration condensate drain lines.

2. Discussion of the Related Art

In various systems and equipment, there is a need to transfer and/or drain liquid from the equipment to a separate location. For example, in air conditioning and refrigeration systems, condensation naturally occurs as warm, humid air passes over the exterior of the evaporator coil in the HVACR unit. Typically, the condensation drips from the evaporator coil into a condensate collection pan positioned below the evaporator coil. From the collection pan, the liquid condensate is directed through a drain line that leads to an appropriate discharge location, such as the exterior of a building. It is not uncommon for these and other types of drain lines to occasionally become partially or completely clogged, resulting in a backup of condensate liquid in the drain line and the collection pan of the HVACR unit. In particular, the slow and continuous movement of condensate liquid through the drain line (i.e., by gravity transfer) encourages the growth and accumulation of algae, bacteria, dust, corrosive residue and other debris that builds up in the drain line and eventually causes a partial or complete blockage. The backup of condensate in the drain line and collection pan can result in an accidental overflow of condensate during the continuous operation of the HVACR equipment, possibly resulting in extensive and costly damage to the building structure and contents. This is a common problem that is well known in the industry.

In order to avoid clogs and accidental condensate overflows in HVACR condensate drain lines, it is recommended that the drain lines be cleaned (i.e., cleared of debris and residue) at least twice a year during normal maintenance procedures. Typically, cleaning of drain lines is achieved by introducing a pressurized flow of liquid or gas through one end of the drain line which serves to push debris, residue and blockages through the drain line and out through the opposite end. In most instances, when using a pressurized flow through the drain line for cleaning, it is desirous to gain access to the upper end of the condensate drain line near the air conditioner or refrigeration unit so that the pressure may be applied at the upper end, while pushing the clogging materials out through the opposite end, usually at an exterior of the building. Access to the upper end of the drain line requires detaching the drain line from the air conditioning or refrigeration unit and then replacing the drain line wherein the maintenance is completed. In many instances, access to the drain line can only be achieved by cutting the drain line near the HVACR unit to create an open end for injection of a pressurized gas or fluid. After cleaning, the cut drain line must then be repaired by inserting a connecting joint. This repair process compromises the water tight integrity of the drain line, and can often result in leaks at the repair joint.

In order to overcome the above-described problems associated with drain line clogs and maintenance for cleaning drain lines in HVACR systems, others have proposed for the installation of permanent inline assemblies that allow for access to the drain line to inject pressurized gas or liquid without the need of separating the drain line from the equipment or cutting the drain line. These various inline assemblies typically employ the use of a manually operated ball valve or gate valve that is closed during the clean out procedure so that the forced flow of gas or liquid is directed in one direction, usually away from the HVACR equipment. Use of a valve is advantageous in order to close off the drain line between the valve and a clog in the line. The pressurized flow of gas or liquid can then be introduced into the drain line between the closed valve and the clog, creating sufficient pressure to push the clog out through the line until the drain line is completely cleared of debris and clogging residue. After the cleanout procedure, the manually operated valve must be opened by the service person, otherwise the closed valve will act as a clog by preventing flow and draining of condensate liquid through the drain line to the desired discharge location.

The need to operate a manual shut-off valve in the various inline drain flushing systems of the related art presents several problems. In particular, the rotational force exerted on the manual valve control can cause bending or breaking of the drain line pipe and/or connecting joints, especially over time when the valve accumulates residue and tends to stick and resist movement. Eventually, the valve would need to be replaced which requires cutting the drain line at two locations. Another major concern with use of manually operated shut-off valves along an HVACR drain line is human error. If the service person forgets to re-open the valve after cleaning the drain line, the liquid condensate will not be permitted to drain out from the drain line and will, instead, back up into the HVACR unit drain pan, possibly resulting in an accidental overflow as the HVACR unit continues to operate.

An attempt to address the above-stated problems can be found in U.S. Pat. No. 7,930,898 to Laufenberg, which discloses an A/C drain line device that allows for flushing of blockages in the drain line. The Laufenberg device includes a flapper that normally hangs straight down and is always in partial obstruction to the drain line. A stop member limits opening of the flapper so that the flapper remains a partial obstruction to the drain line during flushing of blockages. The partial obstruction created by the Laufenberg flapper can cause blockages if debris or a clog from upstream is moved through the drain line and can't pass through the reduced sized passage caused by the partial obstruction of the flapper. International Mechanical Code section 307.2.2 states, in part, that the condensate waste and drain line shall not decrease in diameter size from the drain pan connection to the place of the condensate disposal. The Laufenberg device does not allow for injection of pressurized air/gas, liquid or vacuum force in the opposite upstream direction to clean clogs between the condensation producing source (e.g., HVAC unit) and the Laufenberg device. A further limitation of the Laufenberg device is the inability to remove the flapper to allow for connection of an adapter to direct a pressurized flow of air/gas, liquid or vacuum force in the upstream direction (or downstream direction). Additionally, the Laufenberg device does not permit full, unobstructed inline access to the drain line. Access is provided through a tubular member of the Y-shaped device which limits access to the drain line.

Therefore, with the foregoing reasons in mind, there exists a need for a drain line access device that is structured for inline installation to an existing drain line without obstructing the flow of drain line contents, and which permits convenient flushing of the drain line in both upstream and downstream directions.

### OBJECTS AND ADVANTAGES OF THE INVENTION

Considering the forgoing, it is a primary object of the present invention to provide inline access to fluid transfer lines, such as drain lines in HVACR systems, for purposes of cleaning (e.g., flushing) the lines without disrupting the integrity of the lines and without the need to manually operate shut-off valves to perform the cleaning.

It is a further object of the present invention to provide a drain line access device that allows for easy connection of a compressed gas or liquid delivery source to clean the line and clear any clogs.

It is still a further object of the present invention to provide a drain line access device for cleaning fluid transfer lines and clearing clogs either upstream or downstream of the device.

It is yet a further object of the present invention to provide a drain line access device that has an easily removable cover for providing convenient access and insertion of adapters for flushing the drain line in either direction without cutting, damaging or disrupting the fluid transfer line (e.g., drain line).

These and other advantages of some embodiments are more readily apparent with reference to the detailed description and accompanying drawings.

### SUMMARY OF THE INVENTION

The present invention is directed to a drain line valve device for clearing HVACR drain lines. The device includes a main valve body having connection ports on opposite ends for inline installation to a drain line (between the condensation producing source and drain discharge). In one embodiment, the device includes a removable top cover and an adapter that is sized and configured for insertion into the interior cavity of the main body and fitted receipt within the inside of one of the input or outlet ports (upstream or downstream direction). The adapter allows for connection of virtually any pressurized gas or liquid flow source, or a vacuum source, as well as pouring of a liquid (e.g. unclogging liquid) either upstream or downstream in the drain line for flushing out a clog in the drain line. An alternative embodiment of the device includes a main valve body having one connection port for connection with the auxiliary outlet of a drain pan. An overflow safety switch and/or liquid level sensor and alarm (e.g. float switch) is supported by the top cover in the interior cavity of the main valve body for detecting when the drain pan overflows.

### BRIEF DESCRIPTION OF THE DRAWINGS

For a fuller understanding of the nature of the present invention, reference should be made to the following detailed description, taken in conjunction with the accompanying drawings in which:

FIG. 1 is a side elevational view showing the drain line access device of the present invention installed inline to a drain line between a condensation producing source (e.g., an air handler unit of an HVACR system) and a drain discharge, wherein the drain line is shown in cut-away on opposite sides of the device;

FIG. 2 is a top plan view of the drain line access device of FIG. 1;

FIG. 3 is an exploded top plan view of the drain line access device shown installed inline to a drain line with the top cover removed from the main body by separation of female hinge members from male hinge members of the double pin hinge assembly;

FIG. 4 is a side elevational view of an adapter for use in conjunction with the drain line access device of the present invention;

FIG. 5A is a side elevational view, shown in partial cross-section, showing the main body of the device with the top cover removed and the adapter installed in the downstream direction of the drain line;

FIG. 5B is a side elevational view, shown in partial cross-section, showing the main body of the device with the top cover removed and the adapter installed in the upstream direction of the drain line;

FIG. 6 is an end elevational view shown from the input end of an alternative embodiment of the drain line access device of the present invention, with an overflow safety switch secured to the top cover and suspended within the interior cavity of the main body;

FIG. 7 is an end elevational view of the drain line access device of FIG. 6, with the top cover open;

FIG. 8 is a side elevational view, shown in partial cross-section, illustrating the drain line access device of FIG. 6 installed inline to a drain line and allowing condensate liquid flow through the device;

FIG. 9 is a side elevational view, shown in partial cross-section, illustrating an alternative embodiment of the drain line access device installed inline to a drain line and allowing condensate liquid flow through the device;

FIG. 10 is a side elevational view, shown in partial cross-section, illustrating an alternative embodiment of the drain line access device having one connector port for inline installation on a drain line or directly to a drain pan auxiliary outlet of an HVAC unit;

FIG. 11 is a side elevational view, shown in partial cross-section, illustrating an alternative embodiment of the drain line access device having opposing inlet ports for inline installation on a drain line;

FIG. 12 is a side elevational view of the drain line access device, shown partially exploded, with a cap for sealing a connector port opening and a coupling for securing the device to the auxiliary outlet of a drain pan;

FIG. 13 is a top plan view of an adapter holder for stowing the adapter on the device when the adapter is not in use; and

FIG. 14 is a top plan view showing the drain line access device of the present invention with the adapter holder of FIG. 13 secured thereto and stowing the adapter.

Like reference numerals refer to like reference parts throughout the several views of the drawings.

### DETAILED DESCRIPTION OF THE PREFERRED EMBODIMENT

Referring to the several views of the drawings, the drain line access device of the present invention for clearing HVACR drain lines 100 is shown and is generally indicated as 10.

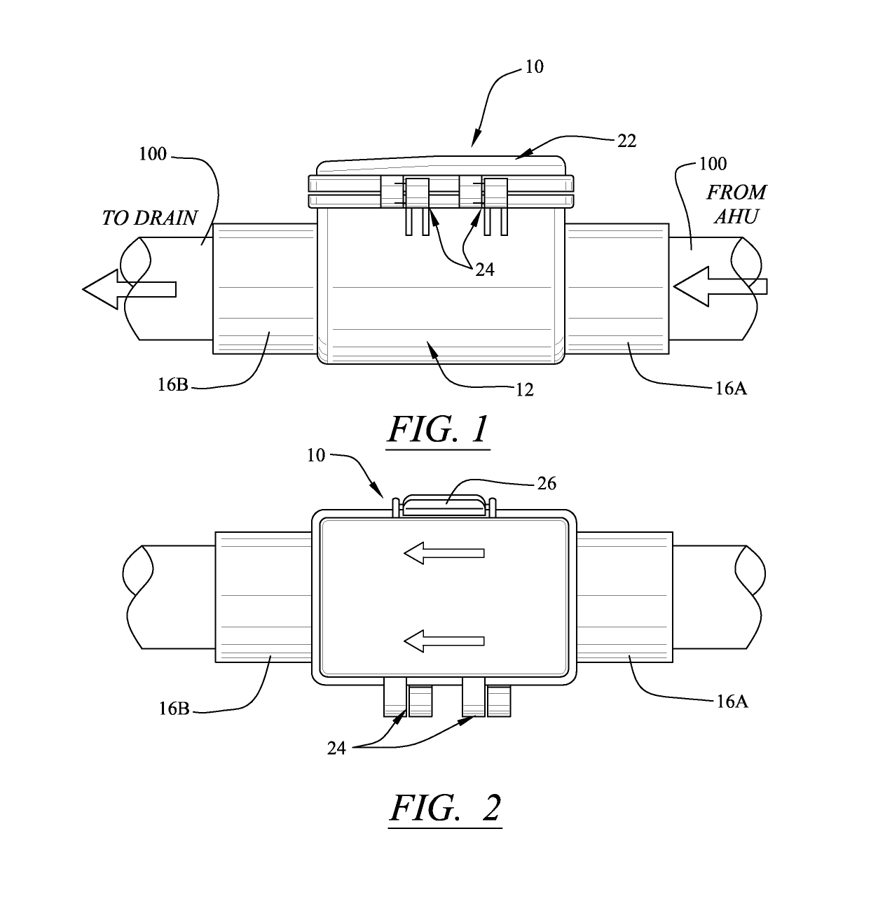

Referring initially to FIGS. 1-6, the device 10 includes a main valve body 12 surrounding interior cavity 14 and having top opening 15 and input and outlet connector ports 16A and 16B on opposite ends, each being sized and configured for engaged receipt of opposing ends of drain line 100 for inline installation. In one embodiment, input port 16A is sized and configured for engaged receipt of drain line 100 extending from a condensation producing source (e.g., an air handler unit of an HVAC unit) and outlet port 16B is sized and configured for engaged receipt of drain line 100 extending to a drain. Top cover 22 is hingedly secured to one side of the valve body 12 by double pin separating hinge assembly 24, including removable male hinge members 25A and female hinge members 25B. The top cover 22 is releasably secured to valve body 12 by a latch mechanism 26 on the side opposite the hinge assembly 24. Top cover 22 is sized and configured to seal the open top of valve body 12 when in the closed position to form an inner channel 28 between input and outlet connector ports 16A and 16B and opposing ends of drain line 100.

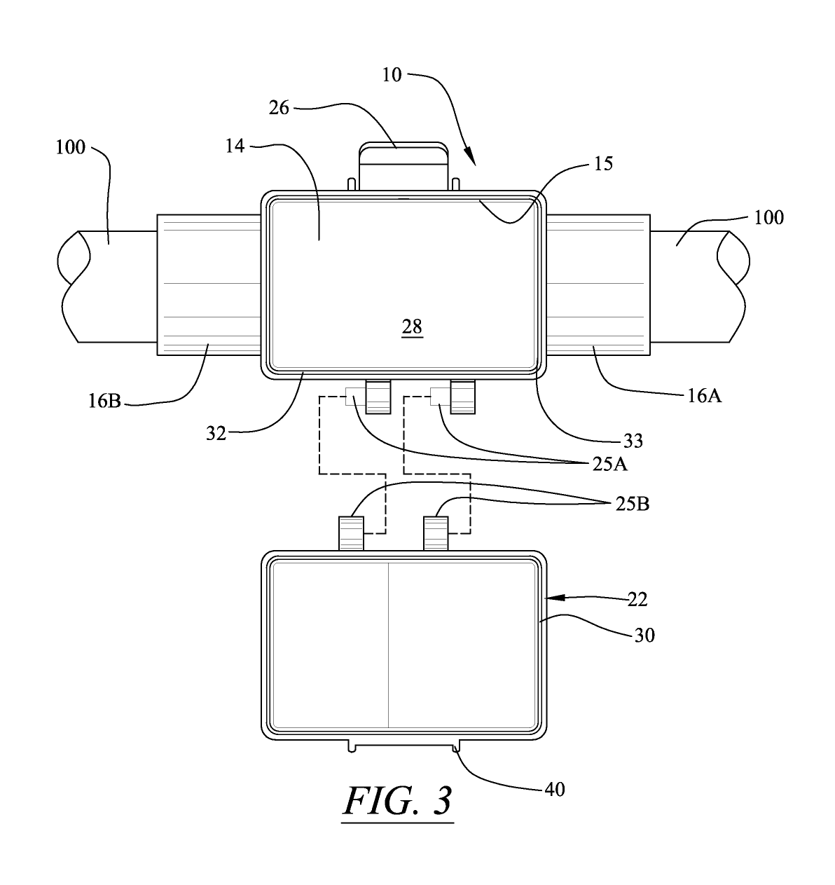

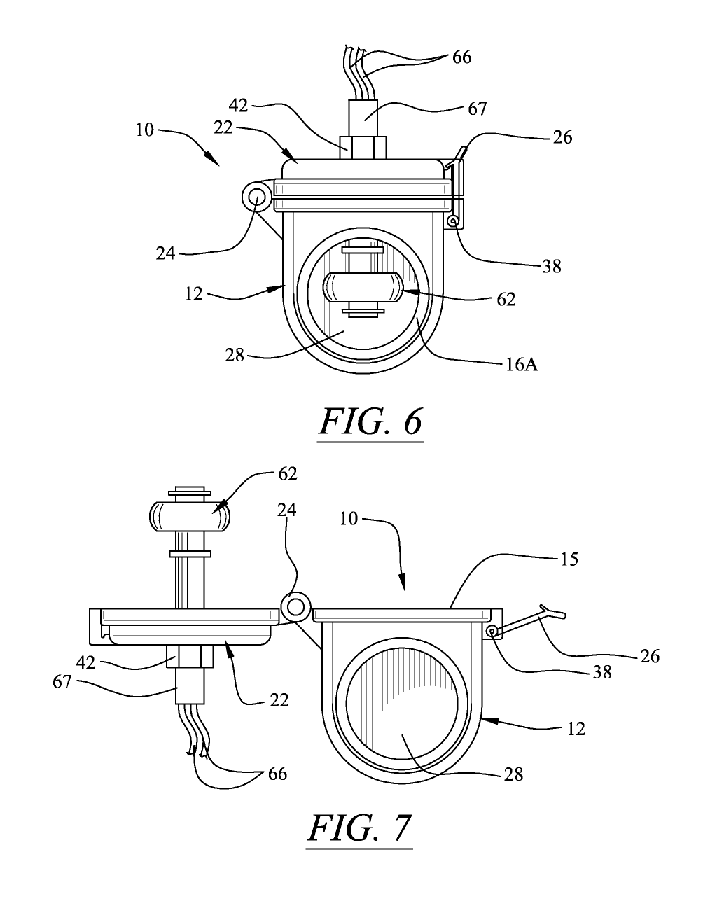

Referring to FIG. 3, top cover 22 includes groove 30 for receiving top cover seal or gasket 32 when top cover 22 is closed against the top edge 33 of valve body 12 surrounding opening 15. The gasket 32 is fitted about the outer rim of the top cover 22 which, when the top cover 22 is in the closed position against the top opening 15 of the valve body 12, serves to produce a watertight and airtight seal. Top cover 22 is easily removable from valve body 12 at a double pin separating hinge assembly 24 by taking out male hinge members 25A of double pin separating hinge assembly 24 from female hinge members 25B. A latch 26 is rotatable about pin 38 (FIG. 6) and can be latched to fastening member 40 on top cover 22 for sealing top opening 15. To open top cover 22, latch 26 can be unlatched from fastening member 40 and rotated away from top cover 22 about pin 38 to allow for top cover 22 to be opened, wherein top cover 22 is rotated about double pin separating hinge assembly 24. While the double pin separating hinge assembly 24 is shown in the drawings on one side of valve body 12, there are embodiments of the device 10 wherein it is advantageous for the hinge assembly 24 to be located on the front or back side of the valve body 12, such that the top cover 22 pivots in the direction of the inner channel 28 when being opened and closed.

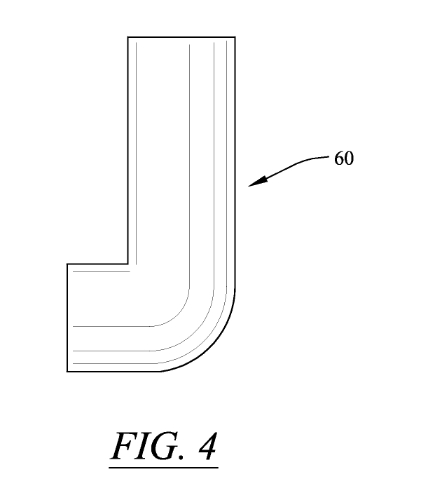

Referring to FIG. 4, an adapter 60 surrounding an inner channel is used in conjunction with the valve body 12 in order to facilitate introducing a liquid or gas into the drain line 100. The adapter 60 includes a 90-degree angle and is sized and configured to be partially inserted into interior cavity 14 through top opening 15. One end of the adapter 60 engages one of either the input or outlet connector ports 16A or 16B to allow for easy pouring of the liquid into the opposite end of the adapter 60. While the adapter 60 shown and described includes a 90-degree bend, the angle of the bend on adapter 60 could be between 0-degrees and 180-degrees.

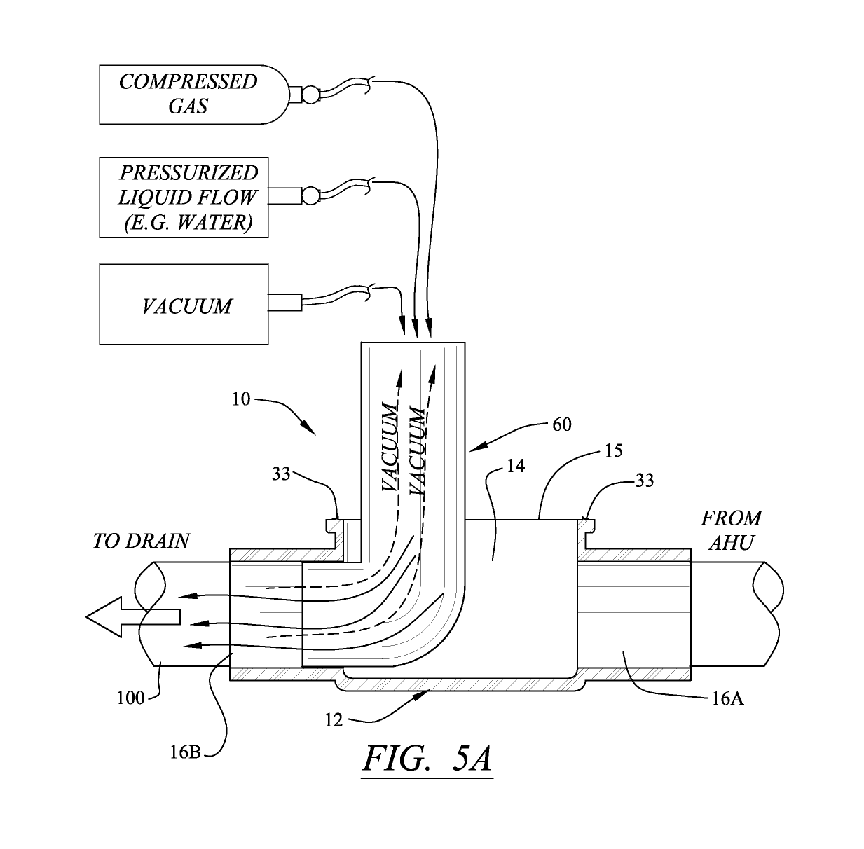

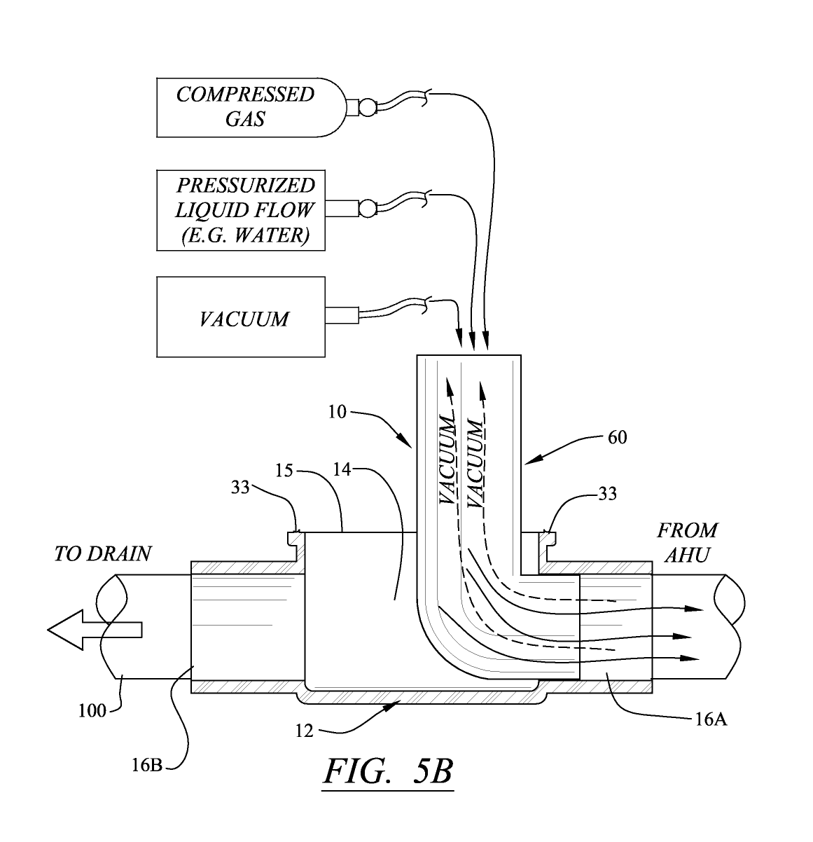

Referring to FIGS. 5A and 5B, the adapter 60 is shown installed in the downstream and upstream directions, respectively, wherein the adapter 60 engages one of the input and outlet connector ports 16A and 16B. A flow of pressurized gas is directed from a compressed gas source through the adapter 60 and then enters one of the connecter ports 16A and 16B, which is in connection with drain line 100, for flushing out a clog. Alternatively, a pressurized liquid flow (e.g., water) may be directed through the adapter 60 for flushing out the clog. When a vacuum force is used for clearing a clog, a vacuum may be attached to the adapter 60. For each of the above applications (i.e., compressed gas, pressurized liquid flow, and vacuum), a coupling may be used between the connector hose and the adapter 60 to ensure a watertight and/or airtight seal.

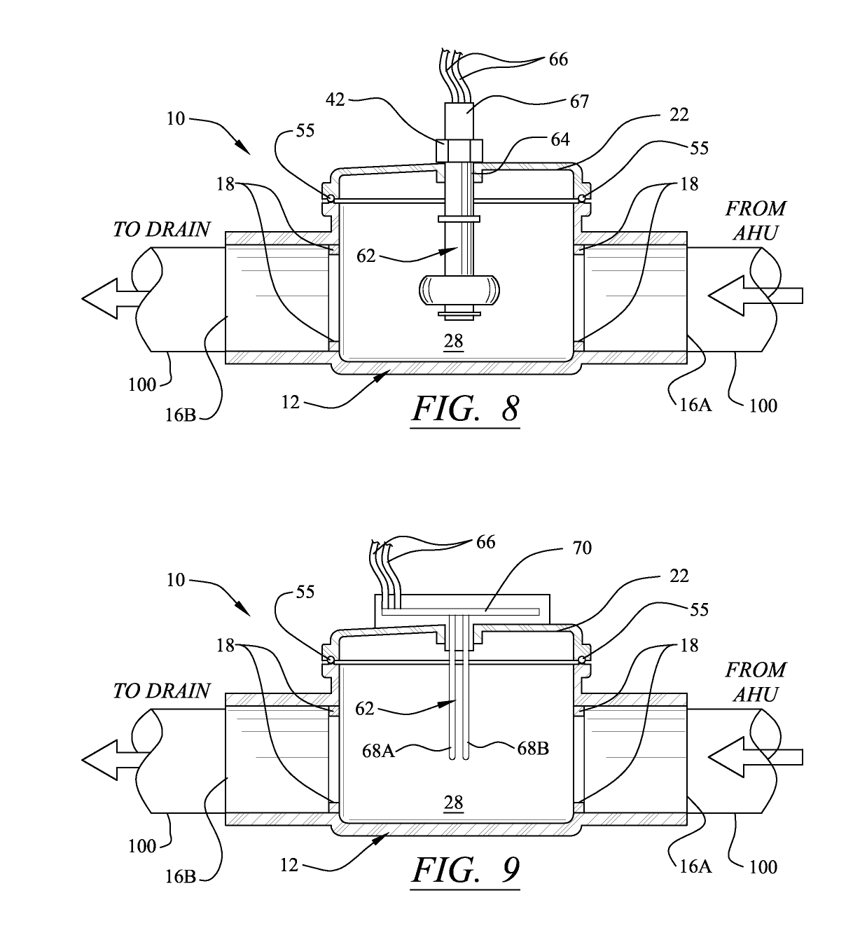

Referring to FIGS. 6-8, an alternative embodiment is shown wherein the top cover 22 includes an overflow safety switch 62 or liquid level sensor and alarm (i.e., float switch) secured thereto extending through opening 64. In one embodiment, the overflow safety switch 62 is secured to the top cover 22 by a threaded nut 42. The overflow safety switch 62 may be in threaded connection with the top cover 22 or otherwise affixed to top cover 22. When the top cover 22 is in the closed position, the overflow safety switch 62 is held in position within the interior cavity 14 of the main valve body 12 and is provided for sensing a rise in the water level, indicating the existence of a clog. The overflow safety switch 62 is electrically connected with a power source by wiring 66, of which at least a portion is protected by wire sleeve 67, for automatically shutting off the HVAC unit when the water level reaches a predetermined level for preventing an overflow.

Each connector port 16A and 16B may include an annular shoulder 18 sized and configured for coming into abutment with the distal end of drain line 100 when connected to a respective connector port 16A or 16B of the valve body 12.

Referring to FIG. 9, an alternative embodiment of overflow safety switch 62 includes probe pins 68A and 68B in connection with a PC board 70 that is affixed to the top cover 22 for automatically shutting off the HVAC unit when the water is detected by pins 68A and 68B. In operation, if the water level within the interior cavity 14 of the valve body 12 rises to a level reaching both the probe pins 68A and 68B, thereby completing the electric circuit with the PC board 70, a signal is automatically sent to shut off the HVAC unit.

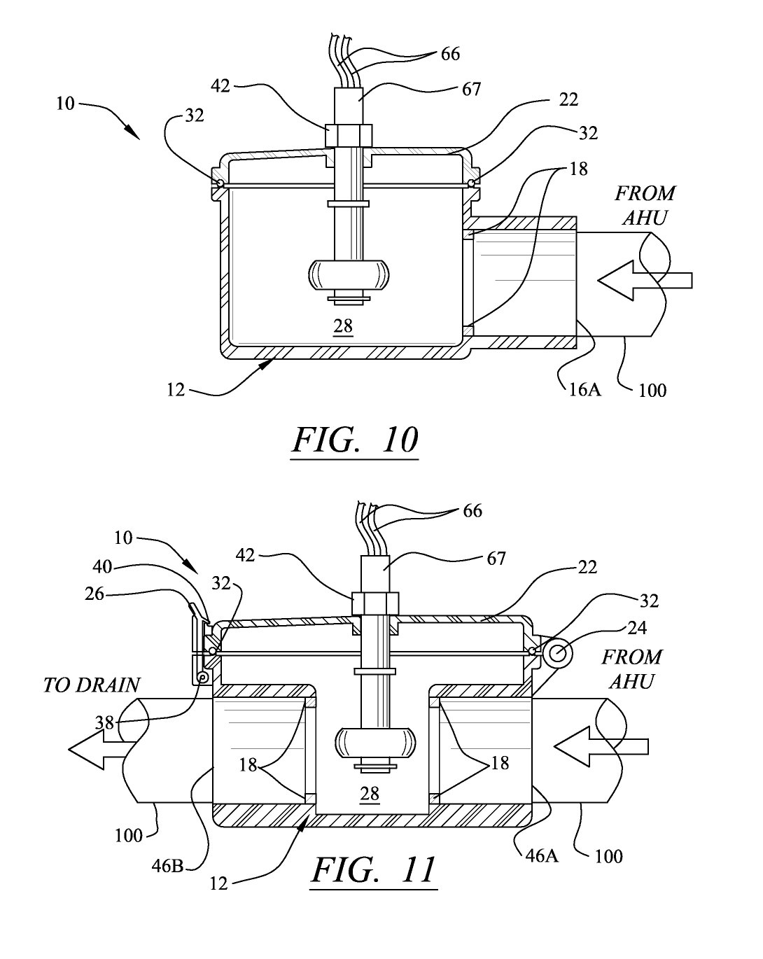

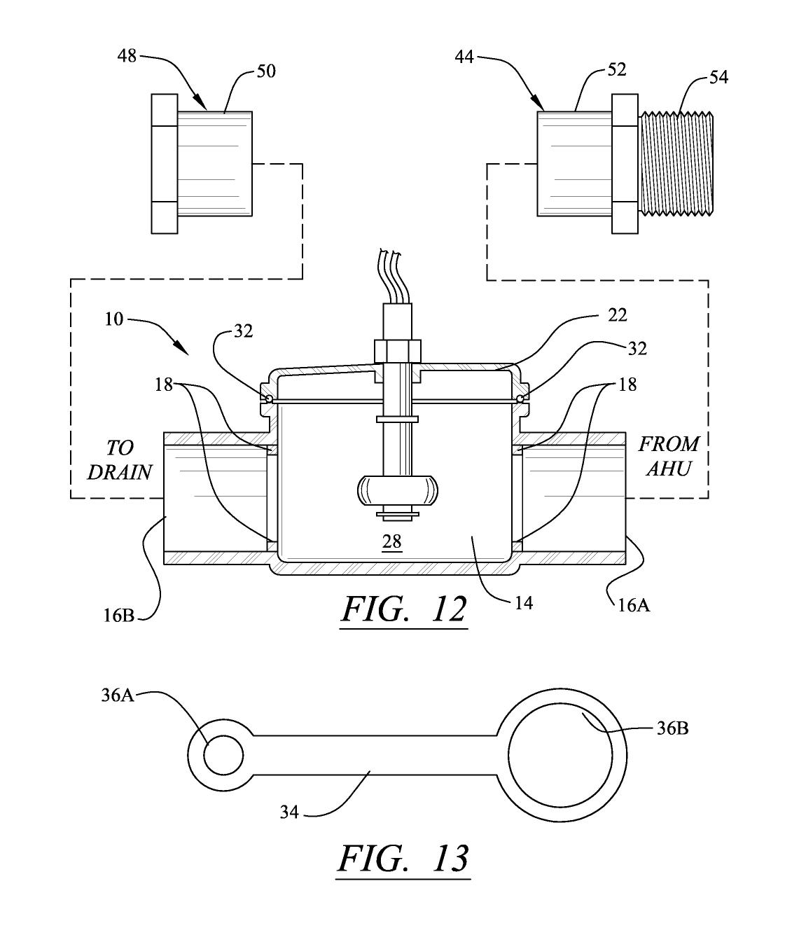

Referring to FIG. 10, an alternative embodiment of the device 10 is shown, wherein the valve body 12 includes only one connector port 16A or 16B. Alternatively, a cap (e.g., screw-on cap) may be used to seal one of the two openings on the embodiment of the main valve 12 including two connector ports 16A and 16B. This alternative embodiment of the device 10 is structured for securing to the auxiliary outlet of a drain pan. The connector port 16A may be molded with threads for screwing directly into the auxiliary outlet or, alternatively, a coupling 44 (FIG. 12) having a lengthwise channel extending therethrough may be used for securing a watertight and airtight seal between the connector port 16A and auxiliary outlet.

Referring to FIG. 11, one embodiment of the drain line access device 10 may include recessed ports 46A and 46B that are each sized and configured for engaged receipt of drain line 100 extending from a condensation producing source and drain line 100 extending to a drain, respectively. The space in the interior cavity 14 between the opposing recessed ports 46A and 46B is sufficient for lowering the adapter 60 therebetween and selectively engaging one of the two recessed ports 46A or 46B.

Referring to FIG. 12, a valve body 12 having two connector ports 16A and 16B (or two recessed ports 46A and 46B) can be converted into the embodiment of the device 10 shown in FIG. 10 and described above. A cap 48 includes an annular wall 50 that is sized and configured for engaged, congruent receipt within the connector port 16B for producing an airtight and liquid tight seal between the cap 48 and interior cavity 14 of the valve body 12. A coupling 44 having a lengthwise channel extending therethrough includes an annular wall 52 at one end that is sized and configured for engaged, congruent receipt within the connector port 16A for producing an airtight and liquid tight seal. The opposite end of the coupling 44 includes a threaded exterior surface 54 sized for threaded, engaged attachment with the auxiliary outlet of a drain pan.

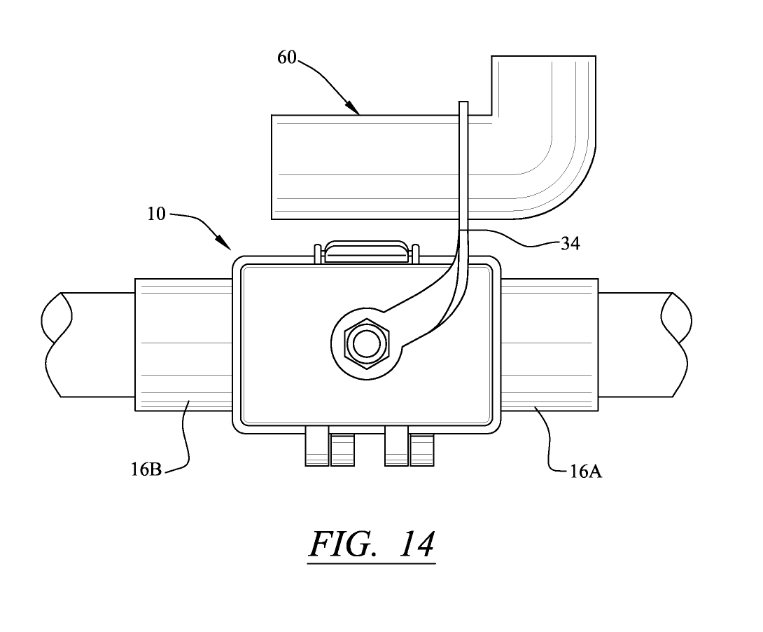

Referring to FIGS. 13 and 14, a holder 34 is provided for stowing adapter 60 and includes loops 36A and 36B for securing the holder 34 to adapter 60 and threaded nut 42, respectively, when the adapter 60 is not in use. In one embodiment, the holder 34 is made from rubber or similar material.

While the present invention has been shown and described in accordance with several preferred and practical embodiments, it is recognized that departures from the instant disclosure are contemplated within the spirit and scope of the present invention which are not to be limited except as defined in the following claims as interpreted under the Doctrine of Equivalents.

What is claimed is:

1. An access device for inline installation on a drain line between a condensation producing source and a drain discharge, and said device comprising:
a main body having an inner wall surface extending to an inner bottom surface and surrounding an interior cavity, and said main body including an input connecting port sized and configured for sealed connection with the drain line and an outlet connecting port sized and configured for sealed connection with an opposite facing end of the drain line, and a flow passage extending through said interior cavity between said input and outlet connecting ports and the flow passage being at least as large as a cross-sectional dimension of an interior flow passage of the drain line;
a top cover being releasably securable to said main body by a latch mechanism for accessing the interior cavity of said main body; and
an adapter having a tubular main body bent at an angle, and said tubular main body having an inner channel extending between a first open end being sized and configured for selective attachment with an inner facing side of either of said input connecting port or said outlet connecting port and a second open end being sized and configured for receiving a flow of liquid or gas therethrough.

2. The device as recited in claim 1 wherein at least one of said input and outlet connecting ports are recessed and extend into the interior cavity of said main body.

3. The device as recited in claim 1 wherein the first open end of said adapter is structured and disposed for receiving a flow of pressurized gas or liquid therethrough and delivering the flow of pressurized gas or liquid into the flow passage.

4. The device as recited in claim 1 wherein the first open end of said adapter is structured and disposed for receiving a vacuum force therethrough.

5. The device as recited in claim 1 further comprising an overflow safety switch that is secured to and held in position within the interior cavity of said main body by said top cover, and said overflow safety switch being structured and disposed for detecting if the liquid level within the interior cavity of said main body reaches a predetermined level and subsequently sending a shut-off signal to the condensation producing source.

6. The device as recited in claim 5 wherein said overflow safety switch is a float switch.

7. The device as recited in claim 5 wherein said overflow safety switch comprises a plurality of probe pins in connection with a PC board.

8. The device as recited in claim 1 further comprising:
a cap having an annular cap wall that is sized and configured for congruent, engaged receipt within at least one of said input and outlet connector ports, and said cap being structured and disposed for forming an airtight and liquid tight seal between the annular cap wall and flow passage of said main body; and
a coupling having a first end and an opposite second end, wherein the first end includes an annular coupling wall surrounding a lengthwise channel, said annular coupling wall being sized and configured for congruent, engaged receipt within at least one of said input and outlet connector ports, and wherein the second opposite end is sized and configured for attachment to an auxiliary outlet of a drain pan.

9. The device as recited in claim 1 further comprising a holder that is securable to said top cover, and said holder including at least one loop that is sized and configured for stowing said adapter when said adapter is not in use.

10. An access device for inline installation on a drain line between a condensation producing source and a drain discharge, and said device comprising:
a main body having an inner wall surface extending to an inner bottom surface and surrounding an interior cavity, and said main body including at least one connecting port sized and configured for sealed connection with the drain line;
a top cover being releasably securable to said main body by a latch mechanism for accessing the interior cavity of said main body;
an overflow safety switch that is secured to and held in position within the interior cavity of said main body by said top cover, and said overflow safety switch being structured and disposed for detecting if the liquid level within the interior cavity of said main body reaches a predetermined level and subsequently sending a shut-off signal to the condensation producing source; and
an adapter having a tubular main body bent at an angle, and said tubular main body having an inner channel extending between a first open end being sized and configured for selective attachment with an inner facing side of said at least one connecting port and a second open end being sized and configured for receiving a flow of liquid or gas therethrough.

11. The device as recited in claim 10 wherein said at least one connecting port is recessed and extends into the interior cavity of said main body.

12. The device as recited in claim 10 wherein the first open end of said adapter is structured and disposed for receiving a flow of pressurized gas or liquid therethrough and delivering the flow of pressurized gas or liquid into the interior cavity.

13. The device as recited in claim 10 wherein the first open end of said adapter is structured and disposed for receiving a vacuum force therethrough.

14. The device as recited in claim 10 wherein said overflow safety switch is a float switch.

15. The device as recited in claim 10 wherein said overflow safety switch comprises a plurality of probe pins in connection with a PC board.

16. The device as recited in claim 10 further comprising a coupling having a first end and an opposite second end, wherein the first end includes an annular coupling wall surrounding a lengthwise channel, said annular coupling wall being sized and configured for congruent, engaged receipt within said at least one connector port, and wherein the second opposite end is sized and configured for attachment to an auxiliary outlet of a drain pan.

17. The device as recited in claim 10 further comprising a holder that is securable to said top cover, and said holder including at least one loop that is sized and configured for stowing said adapter when said adapter is not in use.
